(19) United States
(12) Patent Application Publication
(10) Pub. No.: US 2023/0219560 A1
(43) Pub. Date: Jul. 13, 2023

(54) VEHICLE AND VEHICLE CONTROL METHOD

(71) Applicant: TOYOTA JIDOSHA KABUSHIKI KAISHA, Toyota-shi (JP)

(72) Inventor: Yoshitaka FUJITA, Susono-shi (JP)

(73) Assignee: TOYOTA JIDOSHA KABUSHIKI KAISHA, Toyota-shi (JP)

(21) Appl. No.: 18/150,007

(22) Filed: Jan. 4, 2023

(30) Foreign Application Priority Data
Jan. 7, 2022 (JP) 2022-001866

(51) Int. Cl. B60W 30/02; B60W 10/184; B60W 10/22

(52) U.S. Cl. CPC B60W 30/02; B60W 10/22; B60W 10/184; B60W 2710/18; B60W 2710/226

(57) ABSTRACT

A vehicle includes a brake device, a suspension, and an electronic control unit configured to: control the brake device such that, in at least a part of a first range being a required deceleration range lower than a lower limit value of a vehicle deceleration perceivable by a person in the vehicle, a front-rear distribution ratio is constant regardless of the vehicle deceleration, and, in a second range in which the vehicle deceleration is higher than that in the first range, the front-rear distribution ratio is biased toward a rear wheel than in the first range; and in a specific deceleration range including the second range and higher than the first range, execute at least one of reducing a compression-side damping force of a front wheel damper compared with the first range and increasing an extension-side damping force of a rear wheel damper compared with the first range.

### CROSS-REFERENCE TO RELATED APPLICATION

The present disclosure claims priority under 35 U.S.C. §119 to Japanese Patent Application No. 2022-001866, filed on Jan. 7, 2022, which is incorporated herein by reference in its entirety.

### BACKGROUND

### Technical Field

The present disclosure relates to a vehicle and a vehicle control method.

### Background Art

JP 2019-177736 A discloses a brake control device for a vehicle. This brake control device calculates a target front-rear braking force distribution ratio, which is a target value of a front-rear braking force distribution ratio, based on a target pitch angle of the vehicle at the time of braking, and performs posture control for operating a brake device based on the calculated target front-rear braking force distribution ratio.

### SUMMARY

As a result of earnest research by the inventor of the present disclosure, the following findings have been obtained. That is, a person in a vehicle obtains a feeling of braking not only by the occurrence of the vehicle body deceleration but also by the combination of the occurrence of the deceleration and a change in the vehicle posture. In order to improve the feeling of braking (more specifically, for example, a feeling of deceleration and a sense of security for braking), it is effective to cause a person on board to perceive a change in the vehicle braking posture (i.e., the vehicle posture during braking) which causes a visual change or a bodily sensation change of the person which leads to improvement of the feeling of braking. Also, this kind of change in the vehicle braking posture that leads to the improvement of the feeling of braking differs depending on the deceleration range required at the time of braking.

Moreover, in order to improve the feeling of braking more effectively, it is desirable to be able to control the transitional vehicle posture until a vehicle posture according to a required deceleration of the vehicle is obtained.

The present disclosure has been made in view of the problem described above, and an object of the present disclosure is to provide a vehicle and a vehicle control method that can effectively improve a feeling of braking in a plurality of deceleration ranges by favorably controlling a vehicle braking posture including a transitional vehicle posture.

A vehicle according to the present disclosure includes a brake device, a suspension, and an electronic control unit. The brake device is configured to change a front-rear distribution ratio of wheel braking force. The suspension includes at least one of a front wheel damper with variable damping force and a rear wheel damper with variable damping force. The electronic control unit is configured to: control the brake device such that, in at least a part of a first range being a required deceleration range lower than a lower limit value of a vehicle deceleration perceivable by a person in the vehicle, the front-rear distribution ratio is constant regardless of the vehicle deceleration, and, in a second range in which the vehicle deceleration is higher than that in the first range, the front-rear distribution ratio is biased toward a rear wheel than in the first range; and in a specific deceleration range including the second range and higher than the first range, execute at least one of reducing a compression-side damping force of the front wheel damper compared with the first range and increasing an extension-side damping force of the rear wheel damper compared with the first range.

A vehicle control method according to the present disclosure is a method of controlling a vehicle including a brake device configured to change a front-rear distribution ratio of wheel braking force, and a suspension including at least one of a front wheel damper with variable damping force and a rear wheel damper with variable damping force. This method includes: controlling the brake device such that, in at least a part of a first range being a required deceleration range lower than a lower limit value of a vehicle deceleration perceivable by a person in the vehicle, the front-rear distribution ratio is constant regardless of the vehicle deceleration, and, in a second range in which the vehicle deceleration is higher than that in the first range, the front-rear distribution ratio is biased toward a rear wheel than in the first range; and in a specific deceleration range including the second range and higher than the first range, executing at least one of reducing a compression-side damping force of the front wheel damper compared with the first range and increasing an extension-side damping force of the rear wheel damper compared with the first range.

According to the present disclosure, in the first range of the required deceleration, a front-rear distribution ratio is selected that is more suitable for actively causing a pitch change than in the second range. This makes it possible to cause a person onboard such as a driver to perceive a feeling of deceleration earlier than the perception of the deceleration by using the perception by a change in visual sensation caused by the movement of the head of the person onboard due to the pitch change. As a result, the feeling of deceleration in the first range can be improved. Moreover, in the second range, a front-rear distribution ratio is selected that is more suitable for actively generating an increase in the amount of heave (i.e., diving of the vehicle body) than in the first range. This makes it possible to improve the feeling of security of the person onboard with respect to braking. Furthermore, according to the present disclosure, by controlling at least one of the compression-side damping force of the front wheel damper and the extension-side damping force of the rear wheel damper, a transitional change in vehicle posture is controlled in the specific deceleration range. As a result, a feeling that the vehicle body dives (that is, a feeling of security against braking) can be easily given to the person onboard.

As described above, according to the present disclosure, it is possible to effectively improve a feeling of braking in a plurality of deceleration ranges by favorably controlling a vehicle braking posture including a transitional vehicle posture.

### BRIEF DESCRIPTION OF THE DRAWINGS

FIG. 1 is a diagram schematically illustrating an example of the configuration of a vehicle according to an embodiment;

FIG. 2 is a conceptual diagram showing a configuration example of a suspension according to the embodiment;

FIG. 3 is a diagram used to describe respective displacement amounts ΔX_{f} and ΔXᵣ of front and rear suspensions with respect to braking force;

FIG. 4 is a diagram illustrating a vehicle posture during braking;

FIG. 5 is a graph showing a fixed distribution characteristic and an ideal distribution characteristic used for comparison of braking force distribution characteristics;

FIG. 6 is a graph showing characteristics of pitch angle θp with respect to deceleration Gx in comparison between the fixed distribution characteristic and the ideal distribution characteristic;

FIG. 7 is a graph showing characteristics of heave amount H at a position of the center of gravity with respect to the deceleration Gx in comparison between the fixed distribution characteristic and the ideal distribution characteristic;

FIG. 8 is a graph used to describe a braking force distribution characteristic A used in the embodiment;

FIG. 9A is a graph used to describe an effect of the braking force distribution characteristic A according to the embodiment;

FIG. 9B is a graph used to describe an effect of the braking force distribution characteristic A according to the embodiment;

FIG. 10 is a graph used to describe an issue caused by a brake specification;

FIG. 11A is a diagram used to describe an issue caused by suspension reaction force at the time of braking;

FIG. 11B is a diagram used to describe an issue caused by suspension reaction force at the time of braking;

FIG. 12 is a flowchart showing processing related to vehicle control according to the embodiment;

FIG. 13 is a diagram showing an example of the manner of calculating target damping forces Fdft and Fdrt of front and rear wheel dampers;

FIG. 14A is a time chart used to describe a comparative example;

FIG. 14B is a time chart used to describe an effect of the front-rear damping force control according to the embodiment;

FIG. 15A is a graph illustrating an example of setting of a damping coefficient Cdf according to a modification example of the embodiment;

FIG. 15B is a graph illustrating an example of setting of a damping coefficient Cdr according to the modification example of the embodiment;

FIG. 16 is a graph used to describe an issue on the braking force distribution characteristic A related to securing regenerative electric energy;

FIG. 17 is a flowchart showing processing related to vehicle control according to a modification example of the embodiment;

FIG. 18A is a graph used to describe an effect of processing in steps S202 and S204; and

FIG. 18B is a graph used to describe an effect of the processing in steps S202 and S204.

### DETAILED DESCRIPTION

In the following, embodiments of the present disclosure will be described with reference to the accompanying drawings. However, it is to be understood that even when the number, quantity, amount, range or other numerical attribute of an element is mentioned in the following description of the embodiments, the present disclosure is not limited to the mentioned numerical attribute unless explicitly described otherwise, or unless the present disclosure is explicitly specified by the numerical attribute theoretically.

### 1. Configuration Example of Vehicle

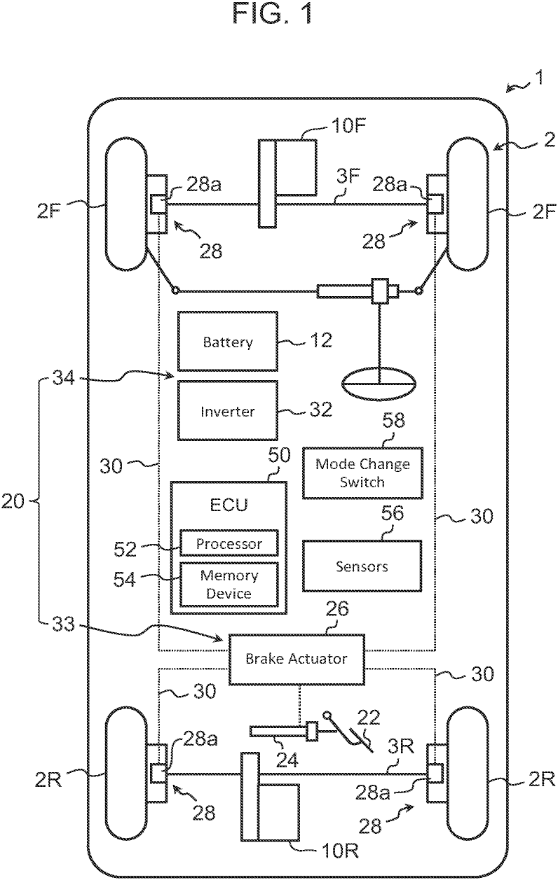

FIG. 1 is a diagram schematically illustrating an example of the configuration of a vehicle 1 according to an embodiment. The vehicle 1 includes four wheels 2. In the following description, front wheels may be collectively referred to as 2F, and rear wheels may be collectively referred to as 2R.

The vehicle 1 includes a front wheel electric motor 10F configured to drive the front wheels 2F via a front wheel drive shaft 3F, and a rear wheel electric motor 10R configured to drive the rear wheels 2R via a rear wheel drive shaft 3R. More specifically, as an example, the vehicle 1 is a hybrid electric vehicle (HEV) including an internal combustion engine together with the electric motors 10F and 10R as the power sources of the vehicle. However, the “vehicle” according to the present disclosure may be, for example, a battery electric vehicle (BEV) driven by the electric motors 10F and 10R that are operated by electric power supplied from a battery 12.

The vehicle 1 includes a brake device 20. The brake device 20 includes a brake pedal 22, a master cylinder 24, a brake actuator 26, brake mechanisms 28, and hydraulic pipes 30. The master cylinder 24 is configured to generate a hydraulic pressure according to the depression force of the brake pedal 22 and supply the generated hydraulic pressure (brake hydraulic pressure) to the brake actuator 26.

The brake actuator 26 includes a hydraulic circuit (not shown) interposed between the master cylinder 24 and the brake mechanisms 28. The hydraulic circuit includes a pump configured to increase the brake hydraulic pressure without depending on the master cylinder pressure, a reservoir for storing brake fluid, and a plurality of electromagnetic valves.

The brake mechanisms 28 are connected to the brake actuator 26 via the hydraulic pipes 30. The brake mechanisms 28 are arranged for the respective wheels 2. The brake actuator 26 is configured to distribute the brake hydraulic pressure to the brake mechanism 28 of each wheel 2. More specifically, the brake actuator 26 can supply the brake hydraulic pressure to the brake mechanism 28 of each wheel 2 using the master cylinder 24 or the above-described pump as a pressure source. Each of the brake mechanisms 28 has a wheel cylinder 28a that operates in accordance with the supplied brake hydraulic pressure. When the wheel cylinder 28a is operated by the brake hydraulic pressure, brake pads are pressed against a brake disc. As a result, a friction braking force is applied to the wheel 2.

Moreover, the brake actuator 26 can independently adjust the brake hydraulic pressure applied to each wheel 2 by controlling various electromagnetic valves provided in the hydraulic circuit. More specifically, the brake actuator 26 has a pressure increasing mode for increasing the pressure, a pressure holding mode for holding the pressure, and a pressure decreasing mode for decreasing the pressure as control modes of the brake hydraulic pressure. The brake actuator 26 can make the control mode of the brake hydraulic pressure different for each wheel 2 by controlling ON/OFF of various electromagnetic valves. The friction braking force applied to each wheel 2 is determined in accordance with the brake hydraulic pressure supplied to each wheel cylinder 28a. By changing the control mode in this manner, the brake actuator 26 can independently control the braking force of each wheel 2.

The brake device 20 includes a regenerative brake device 34 in addition to a friction brake device 33 provided with the master cylinder 24, the brake actuator 26, the brake mechanisms 28, and the hydraulic pipes 30 described above. Specifically, the vehicle 1 includes an inverter 32 configured to drive the electric motors 10F and 10R. The inverter 32 is controlled on the basis of commands from an electronic control unit (ECU) 50 described below. Under the control of the inverter 32, each of the electric motors 10F and 10R functions as an electric motor configured to generate a vehicle driving torque. Each of the electric motors 10F and 10R also functions as a generator configured to be driven by the rotation of the wheels 2F and 2R during deceleration of the vehicle 1 to generate regenerative torque (i.e., negative torque). The magnitude of the regenerative torque is controlled by the inverter 32.

The battery 12 is charged with the regenerative electric power generated by the electric motors 10F and 10R. A front wheel regenerative braking force according to regenerative torque of the front wheel electric motor 10F is applied to the front wheels 2F, and a rear wheel regenerative braking force according to regenerative torque of the rear wheel electric motor 10R is applied to the rear wheels 2R. The regenerative brake device 34 is provided with the electric motors 10F and 10R, the inverter 32, and the battery 12, and can control the front wheel regenerative braking force and the rear wheel regenerative braking force.

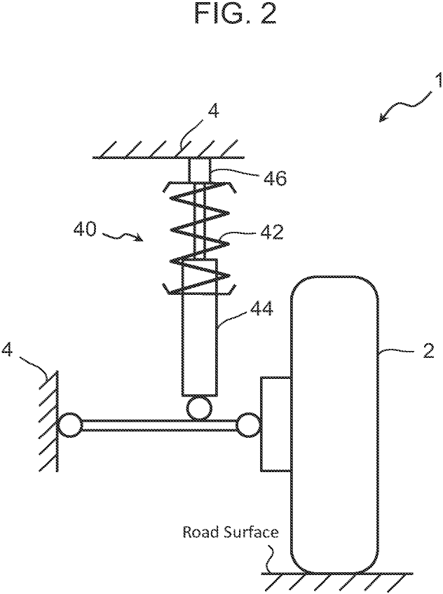

Moreover, the vehicle 1 includes a suspension 40 configured to suspend the wheels 2 from a vehicle body 4. More specifically, the suspension 40 is provided for each wheel 2. FIG. 2 is a conceptual diagram showing a configuration example of the suspension 40 according to the embodiment. The suspension 40 includes a spring 42 and a damper (shock absorber) 44 for each wheel 2. The damper 44 is a variable damping force damper including an actuator 46 configured to change the generated damping force.

Furthermore, as shown in FIG. 1, the vehicle 1 includes the ECU 50. The ECU 50 includes a processor 52, a memory device 54, and an input/output interface. The input/output interface receives sensor signals from sensors 56 mounted in the vehicle 1 and outputs operation signals to various actuators (such as the electric motors 10F and 10R, the brake actuator 26, and the actuators 46 for changing the damping force) and the inverter 32. Various control programs for controlling the various actuators and the inverter 32 are stored in the memory device 54. The processor 52 reads a control program from the memory device 54 and executes the control program, whereby various controls using the various actuators and the inverter 32 are realized. It should be noted that the ECU 50 may be configured by combining a plurality of ECUs.

The sensors 56 described above include, for example, wheel speed sensors, a longitudinal acceleration sensor, a brake position sensor, and suspension stroke sensors. The wheel speed sensors are arranged for the respective wheels 2, and each output a wheel speed signal responsive to the rotational speed of the wheel 2. The longitudinal acceleration sensor outputs an acceleration signal responsive to the acceleration of the vehicle 1 in the longitudinal direction. The brake position sensor outputs a signal responsive to the amount of depression of the brake pedal 22. The suspension stroke sensors each output a signal responsive to the stroke of the corresponding suspension 40.

In addition, a mode change switch 58 is arranged in the interior of the vehicle 1. The mode change switch 58 is an example of an operation device configured to switch the traveling mode of the vehicle 1 in response to an operation of the driver.

### 2. Vehicle Control

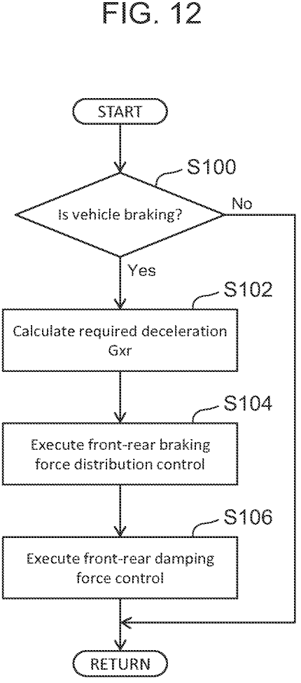

The control of the vehicle 1 performed by the ECU 50 includes a brake control using the brake device 20 and a suspension control. Specifically, the brake control includes a “front-rear braking force distribution control” described below. The suspension control includes a “front-rear damping force control” described below with reference to FIGS. 12 to 14.

### 2-1. Front-Rear Braking Force Distribution Control

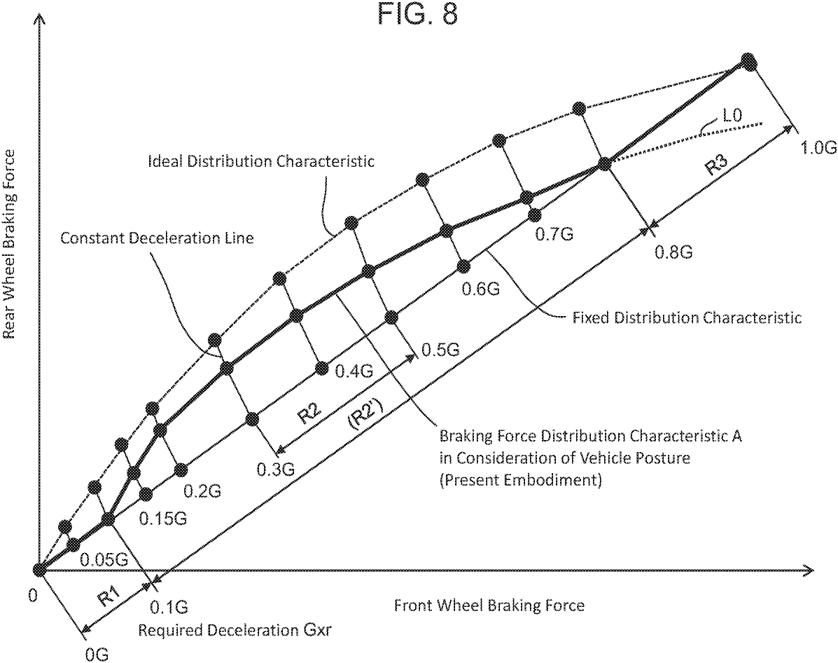

The brake device 20 having the configuration described above can change a front-rear distribution ratio α of wheel braking force (more specifically, the braking forces of the front wheels 2F and the rear wheels 2R). In the present embodiment, as a braking force distribution characteristic of the braking forces applied to the front wheels 2F and the rear wheels 2R by the brake device 20, a braking force distribution characteristic A (see FIG. 8) in which load transfer and suspension reaction force of the vehicle 1 generated during braking are taken into consideration is used.

When the braking force is generated in the front wheels 2F and the rear wheels 2R, a load transfer in the longitudinal direction of the vehicle 1 is generated, and a reaction force of suspensions 40 according to the generated braking force is generated. When the generated suspension reaction force changes, the vehicle posture during braking (hereinafter, also referred to as “vehicle braking posture”) changes. The suspension reaction force can be controlled by adjusting the front-rear distribution ratio α of the braking force.

Accordingly, in the present embodiment, the front-rear braking force distribution control is performed in consideration of the vehicle posture in order to achieve a vehicle braking posture with a high braking feeling (more specifically, for example, a feeling of deceleration and a feeling of security with respect to the braking) of a person on board by using the suspension reaction force. In this front-rear braking force distribution control, the front-rear distribution ratio α of the braking force is changed according to the range of a required deceleration Gxr.

### 21. Change in Vehicle Body Braking Posture by Change in Front-Rear Distribution Ratio

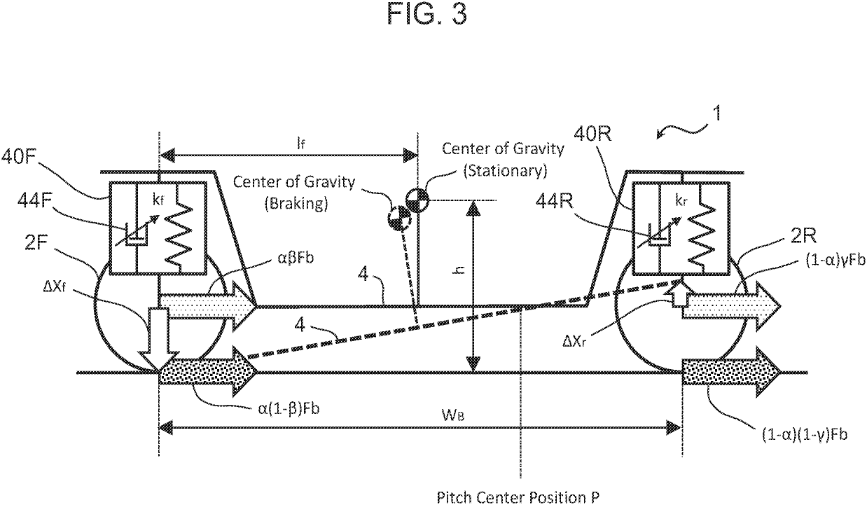

FIG. 3 is a diagram used to describe the respective displacement amounts ΔX_{f} and ΔXᵣ of the front and rear suspensions 40F and 40R with respect to the braking force. The front-rear distribution ratio α of the braking force is a ratio of the braking force applied to the front wheels 2F (front wheel braking force) to the sum (i.e., total braking force Fb) of the front wheel braking force and the braking force applied to the rear wheels 2R (rear wheel braking force). Therefore, the front wheel braking force is αFb and the rear wheel braking force is (1-α)Fb.

More specifically, in the example of the vehicle 1 provided with the brake device 20 including the regenerative brake device 34 together with the friction brake device 33, each of the front wheel braking force and the rear wheel braking force is the sum of the friction braking force and the regenerative braking force. The ratio of the front wheel regenerative braking force to the front wheel braking force (i.e., front wheel regenerative distribution ratio) is herein referred to as β, and the ratio of the rear wheel regenerative braking force to the rear wheel braking force (i.e., rear wheel regenerative distribution ratio) is referred to as γ. As a result, each braking force is expressed as follows.
Front wheel regenerative braking force: αβFb
Front wheel friction braking force: α(1-β)Fb
Rear wheel regenerative braking force: (1-α)γFb
Rear wheel friction braking force: (1-α)(1-γ)Fb

FIG. 3 schematically shows the suspension displacement amounts ΔX_{f} and ΔXᵣ obtained when the total braking force Fb acts on the vehicle 1. That is, as conceptually shown in FIG. 3, at the time of braking, a load transfer is generated, and the posture of a vehicle body (sprung structure) 4 changes such that the front wheel side dives and the rear wheel side lifts. Therefore, the suspensions 40F of the front wheels 2F are stroked to the compression side, and the suspensions 40R of the rear wheels 2R are stroked to the expansion (i.e., rebound) side. The suspension displacement amounts ΔX_{f} and ΔXᵣ during braking are expressed by the following Equations (1) and (2).

$$\text{Δ} {X}_{f} = \left[\frac{h}{{W}_{B}} - α \left\{\left(1 - β\right) ⋅ A n t i D i v e + β ⋅ A n t i L i f t \_ f\right\}\right] \frac{F}{{k}_{f}}$$

$$\text{Δ} {X}_{r} = - \left[\frac{h}{{W}_{B}} - \left(1 - α\right) \left\{\left(1 - γ\right) ⋅ A n t i L i f t \_ r + γ ⋅ A n t i S q u a t\right\}\right] \frac{F}{{k}_{r}}$$

In Equations (1) and (2), W_{B} is the wheelbase and is known. H is the height of the center of gravity when the vehicle is stationary, and is known. K_{f} and kᵣ are the spring constants of the springs 42 of the suspensions 40F and 40R, respectively, and are known.

Moreover, AntiDive is an anti-dive rate. AntiLift_f and AntiLift_r are anti-lift rates on the front wheel side and the rear wheel side, respectively. AntiSquat is an anti-squat rate. More specifically, the suspension 40F has a suspension geometry configured to generate an anti-dive force and an anti-lift force, which are suspension reaction forces, in response to the generation of a braking force. Furthermore, the suspension 40R has a suspension geometry configured to generate an anti-lift force and an anti-squat force, which are suspension reaction forces, in response to the generation of a braking force. Each of the anti-dive rate, the anti-lift rates, and the anti-squat rate in Equations (1) and (2) is a value that indicates a vertical reaction force ratio, and is a known value determined by the specifications of the suspensions 40F and 40R.

In Equation (1), the product of h/W_{B} and the total braking force Fb is related to the amount of load transfer of the vehicle body 4, and corresponds to a force that causes the front wheel side of the vehicle body 4 to dive in the downward direction due to the load transfer. The product of the front wheel friction braking force α(1-β)Fb and AntiDive corresponds to a force that causes the front wheel side of the vehicle body 4 to lift in the upward direction by the anti-dive force that acts as a result of the generation of the front wheel friction braking force α(1-β)Fb. The product of the front wheel regenerative braking force αβFb and the AntiLift_f corresponds to a force that causes the front wheel side of the vehicle body 4 to lift in the upward direction by the anti-lift force that acts as a result of the generation of the front wheel regenerative braking force αβFb.

In Equation (2), the product of h/W_{B} and the total braking force Fb corresponds to a force that causes the rear wheel side of the vehicle body 4 to lift in the upward direction due to the load transfer. The product of the rear wheel friction braking force (1-α)(1-γ)Fb and AntiLift_r corresponds to a force that causes the rear wheel side of the vehicle body 4 to dive in the downward direction by the anti-lift force that acts as a result of the generation of the rear wheel friction braking force (1-α)(1-γ)Fb. The product of the rear wheel regenerative braking force (1-α)γFb and AntiSquat corresponds to a force that causes the rear wheel side of the vehicle body 4 to dive in the downward direction by the anti-squat force that acts as a result of the generation of the rear wheel regenerative braking force (1-α)γFb.

In addition, as shown in FIG. 3, the points of application of the friction braking force and the regenerative braking force are different from each other with respect to each of the front wheels 2F and the rear wheels 2R. That is, the friction braking force acts on the ground contact surface of the wheel 2. On the other hand, the regenerative torque generated by the electric motor 10F is input to the front wheels 2F via the front wheel drive shaft 3F. Therefore, the regenerative braking force acts on the center position of each of the front wheels 2F. Similarly, the regenerative torque generated by the electric motor 10R is input to the rear wheels 2R via the rear wheel drive shaft 3R. Therefore, the regenerative braking force acts on the center position of each of the rear wheels 2R.

By using the suspension displacement amounts ΔX_{f} and ΔXᵣ obtained by Equations (1) and (2) described above, a pitch angle θp of the vehicle 1, a heave amount H at the position of the center of gravity of the vehicle 1, and a pitch center position P that change due to braking are represented by the following Equations (3) to (5), respectively. In Equation (4), 1_{f} is the distance between the front wheel drive shaft 3F and the position of the center of gravity and is known.

$${θ}_{p} = {tan}^{- 1} \frac{\text{Δ} {X}_{f} - \text{Δ} {X}_{r}}{{W}_{B}}$$

$$H = \text{Δ} {X}_{f} + {l}_{f} tan θ$$

$$P = \frac{\text{Δ} {X}_{f}}{\text{Δ} {X}_{f} - \text{Δ} {X}_{r}} {W}_{B}$$

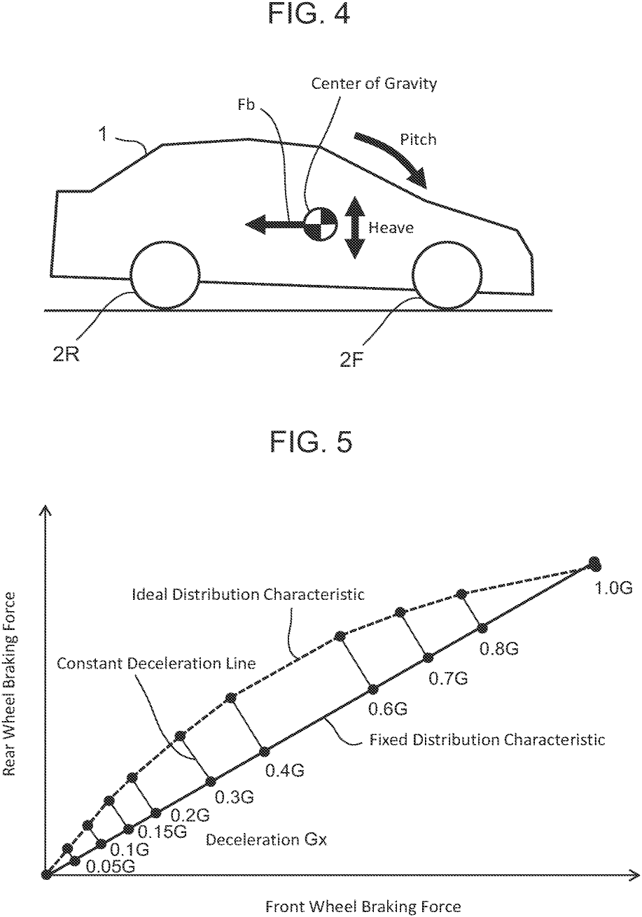

FIG. 4 is a diagram illustrating a vehicle posture (vehicle braking posture) during braking. During braking, an inertial force equal to the total braking force Fb acts toward the front of the vehicle 1. As a result, as shown in FIG. 4, in the vehicle 1, a pitch change occurs such that the front wheel side dives, and a heave change (vertical displacement of the vehicle body 4) occurs. Also, how the pitch angle θp and the heave amount H change due to braking changes by changing the front-rear distribution ratio α. This is because when the front-rear distribution ratio α changes, the suspension displacement amounts ΔX_{f} and ΔXᵣ represented by Equations (1) and (2) described above change.

Additionally, how the pitch angle θp and the heave amount H change due to braking also changes by changing the ratios (regenerative distribution ratios) β and γ. In the present embodiment, as an example, the ratios β and γ are assumed to be constant regardless of the deceleration Gx. However, both or one of the ratios β and γ may be changed in accordance with the deceleration Gx in order to change the manner of changing the pitch angle θp and the heave amount H.

Next, changes in the pitch angle θp and the heave amount H associated with a change in the front-rear distribution ratio α will be specifically described with reference to FIGS. 5 to 7. FIG. 5 is a graph showing a fixed distribution characteristic and an ideal distribution characteristic used for comparison of braking force distribution characteristics.

The “fixed distribution characteristic” referred to here is a braking force distribution characteristic that achieves the front-rear distribution ratio α that is constant regardless of the deceleration Gx of the vehicle 1. This fixed distribution characteristic is achieved, for example, by applying equal hydraulic pressure to the wheel cylinders 28a of the front wheels 2F and the rear wheels 2R. In general, due to a difference in brake specifications between the front and rear wheels 2F and 2R, according to the fixed distribution characteristic, a braking force distribution characteristic that is biased toward the front wheels 2F with a front-rear distribution ratio α of 0.7, for example, is obtained.

Furthermore, the term “ideal distribution characteristic” referred to here is a braking force distribution characteristic that achieves a front-rear distribution ratio α at which the front wheels 2F and the rear wheels 2R are locked at the same time during braking, and can be obtained from the specifications of the vehicle 1. As shown in FIG. 5, in comparison at the same deceleration Gx, according to the ideal distribution characteristic, a braking force distribution characteristic that is biased toward the rear wheels 2R as a whole than the fixed distribution characteristic is obtained.

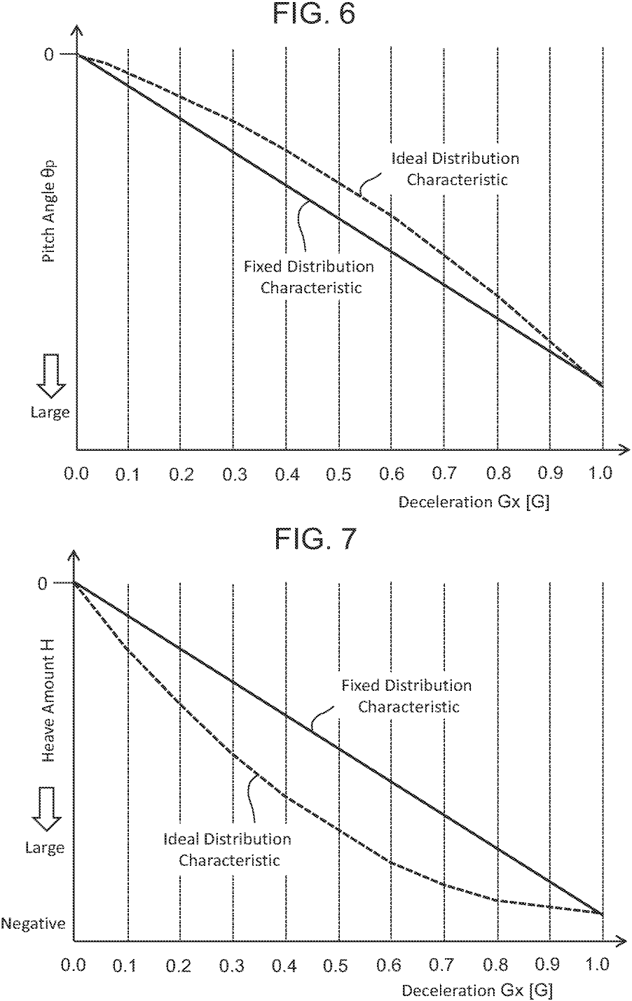

FIG. 6 is a graph showing the characteristics of the pitch angle θp with respect to the deceleration Gx in comparison between the fixed distribution characteristic and the ideal distribution characteristic. According to Equation (3), the pitch angle θp is calculated using the calculation results of the suspension displacement amounts ΔX_{f} and ΔXᵣ according to Equations (1) and (2). As a result, in the fixed distribution characteristic, the pitch angle θp monotonically increases with an increase in the deceleration Gx. On the other hand, as shown in FIG. 6, in the ideal distribution characteristic, the pitch angle θp is smaller as a whole than that in the fixed distribution characteristic. More specifically, in comparison at the same deceleration Gx, the difference in the pitch angle θp basically increases when the difference in the front-rear distribution ratio α increases. As described above, according to the ideal distribution characteristic, an increase in the pitch angle θp is reduced due to the braking force distribution that is biased toward the rear wheels 2R than in the fixed distribution characteristic.

FIG. 7 is a graph showing the characteristics of the heave amount H at the position of the center of gravity with respect to the deceleration Gx in comparison between the fixed distribution characteristic and the ideal distribution characteristic. According to Equation (4), the heave amount H is calculated using the calculation results of the suspension displacement amounts ΔX_{f} and ΔXᵣ according to Equations (1) and (2) and the calculation results of the pitch angle θp according to Equation (3). As a result, the heave amount H in the fixed distribution characteristic monotonically increases with an increase in the deceleration Gx. It should be noted that, in the example shown in FIG. 7, due to braking, the heave amount H takes a negative value, i.e., the vehicle body 5 is displaced downward.

On the other hand, as shown in FIG. 7, in the ideal distribution characteristic, the heave amount H is larger as a whole than that in the fixed distribution characteristic. More specifically, in comparison at the same deceleration Gx, the difference in the heave amount H basically increases when the difference in the front-rear distribution ratio α increases. As described above, in the ideal distribution characteristic, an increase in the heave amount H (i.e., diving of the vehicle body 4) is promoted due to the braking force distribution that is biased toward the rear wheels 2R than in the fixed distribution characteristic.

As can be seen from the description with reference to FIGS. 5 to 7, the pitch angle θp and the heave amount H during braking can be controlled by changing the front-rear distribution ratio α.

### 22. Braking Force Distribution Characteristic in Consideration of Vehicle Posture

When the deceleration Gx is generated, a load transfer occurs in the vehicle body (sprung structure) 4. Also, the sprung posture (i.e., vehicle posture) changes with the occurrence of the load transfer. The change in the sprung posture at this time is caused not only by the load transfer but also by the influence of the suspension reaction forces described above. A timing at which a person onboard such as a driver actually receives the deceleration Gx as the braking feeling (i.e., feeling of deceleration) is delayed from a timing at which the deceleration Gx is generated in the vehicle body 4. That is, it is considered that the person onboard obtains a braking feeling by a combination of the generation of the deceleration Gx of the vehicle body 4 and the change in the sprung posture. More specifically, depending on how the sprung posture changes, the person onboard such as the driver may obtain a feeling of security with respect to the braking or, conversely, it may be difficult for the person to obtain a feeling of deceleration. In other words, controlling the vehicle braking posture by changing the front-rear distribution ratio α means that the feeling received by the person from braking can be changed.

Furthermore, with respect to the perception of the pitch change and the heave change by a person, the following knowledge has been obtained by evaluation by, for example, a test in advance. That is, the pitch change is more easily perceived by the visual sensation than by the bodily sensation. In other words, a person onboard such as a driver easily feels the pitch change by the change of the visual sensation. On the other hand, the heave change is more easily perceived by the bodily sensation than by the visual sensation. In other words, the person onboard such as the driver easily feels the heave change from the bodily sensation of a change in vertical acceleration Gz of the vehicle 1, for example.

FIG. 8 is a graph used to describe a braking force distribution characteristic A used in the embodiment. FIG. 8 also shows the same fixed distribution characteristic and ideal distribution characteristic as those shown in FIG. 5 for comparison with the braking force distribution characteristic A.

As described above, a person in the vehicle 1 obtains the braking feeling not only by the generation of the deceleration Gx but also by the combination of the generation of the deceleration Gx and the change in the vehicle posture. Therefore, in order to improve the braking feeling (more specifically, for example, the deceleration feeling and the feeling of security against braking), it is effective to cause the person to perceive a change in the vehicle braking posture that causes a visual sensation change or a bodily sensation change of the person that leads to the improvement of the braking feeling.

Furthermore, the change in the vehicle braking posture which leads to the improvement of the braking feeling differs depending on the range of the deceleration Gx requested at the time of braking. To be more specific, attention is paid to a low deceleration range R1 and a medium deceleration range R2 that are related to a required deceleration Gxr from the driver. It should be noted that the low deceleration range R1 and the medium deceleration range R2 correspond to examples of a “first range” and a “second range” according to the present disclosure, respectively.

The low deceleration range R1 is a required deceleration range below a lower limit value Gx_{LMT} of the deceleration Gx perceivable by a person onboard such as a driver. The lower limit value Gx_{LMT} is a value that can be grasped in advance by, for example, a test, and is, for example, 0.1G. Alternatively, the lower limit value Gx_{LMT} may be, for example, 0.15G. In this kind of low deceleration range R1, the driver does not feel the deceleration Gx or is at least less likely to feel the deceleration Gx. However, if it is possible to cause the driver to perceive the occurrence of the pitch change during braking that uses the low deceleration range R1, the following effect can be obtained.

That is, the driver empirically knows that the body including the head is going to move forward when the brake pedal 22 is depressed. Also, as described above, a pitch change is easily perceived by using a change in visual sensation. Therefore, if a pitch change is actively caused as the change in such a vehicle braking posture that the driver can quickly perceive the occurrence of the pitch change even if the driver does not feel the deceleration Gx, the driver can be given a feeling of deceleration earlier than the perception of the deceleration by using a change in visual sensation accompanying the pitch change.

Therefore, according to the braking force distribution characteristic A, in the low deceleration range R1, as shown in FIG. 8, the brake device 20 is controlled such that the front-rear distribution ratio α is in accordance with the fixed distribution characteristic. In other words, in the low deceleration range R1, the brake device 20 is controlled such that the front-rear distribution ratio α is biased toward the front wheels 2F than that in the ideal distribution characteristic.

Then, the medium deceleration range R2 is a required deceleration range from 0.3G to 0.5G, for example. Alternatively, the medium deceleration range R2 may be a required deceleration range from 0.3G to 0.6G, for example. According to the braking force distribution characteristic A, in the middle deceleration range R2, as shown in FIG. 8, the brake device 20 is controlled such that the front-rear distribution ratio α is biased toward the rear wheels 2R than that in the fixed distribution characteristic.

More specifically, according to the braking force distribution characteristic A, in the middle deceleration range R2, as shown in FIG. 8, the front-rear distribution ratio α is controlled at values located between the ideal distribution characteristic and the fixed distribution characteristic. Also, according to the braking force distribution characteristic A, in the required deceleration range located between the low deceleration range R1 and the medium deceleration range R2, the front-rear distribution ratio α is changed so as to be gradually biased toward the rear wheels 2R with an increase in the required deceleration Gxr, from the value of the front-rear distribution ratio α in the range R1 toward the value of the front-rear distribution ratio α in the range R2.

It should be noted that, as another example of the “second range” according to the present disclosure, a medium deceleration range R2′ (see FIG. 8) may be used. This medium deceleration range R2′ includes not only the medium deceleration range R2 but also a required deceleration range located between the medium deceleration range R2 and the low deceleration range R1 and a required deceleration range located between the medium deceleration range R2 and the high deceleration range R3. As described above, the “second range” only needs to include the medium deceleration range R2 specified as the required deceleration range of, for example, 0.3G to 0.5G or 0.3G to 0.6G. Therefore, the second range may be regarded as a range continuous with both the low deceleration range R1 and the high deceleration range R3 as in the medium deceleration range R2′, or may be regarded as a range continuous with only one of the ranges R1 and R3.

Furthermore, a high deceleration range R3 exists on the higher deceleration side than the medium deceleration range R2. The high deceleration range R3 is a required deceleration range equal to or higher than the deceleration Gx obtained when the distribution line of the braking force distribution characteristic A and the distribution line of the fixed distribution characteristic intersect at the high deceleration side. In the example shown in FIG. 8, the high deceleration range R3 is a required deceleration range equal to or higher than 0.8G. Alternatively, the high deceleration range R3 may be, for example, a required deceleration range equal to or higher than 0.7G. The upper limit of the high deceleration range R3 is, for example, 1.0G. According to the braking force distribution characteristic A, in the high deceleration range R3, as shown in FIG. 8, the brake device 20 is controlled such that the front-rear distribution ratio α is in accordance with the fixed distribution characteristic.

According to the braking force distribution characteristic A, in the required deceleration range located between the medium deceleration range R2 and the high deceleration range R3, the front-rear distribution ratio α is changed so as to be gradually biased toward the front wheels 2F with an increase in the required deceleration Gxr, from the value of the front-rear distribution ratio α in the range R2 toward the value of the front-rear distribution ratio α in the range R3.

In addition, in each of the low deceleration range R1 and the high deceleration range R3, “controlling the brake device 20 so as to achieve the front-rear distribution ratio α along the fixed distribution characteristic” does not necessarily require that the front-rear distribution ratio α is controlled so as to completely coincide with the fixed distribution characteristic, but includes controlling the brake device 20 so as to achieve the front-rear distribution ratio α substantially along the fixed distribution characteristic.

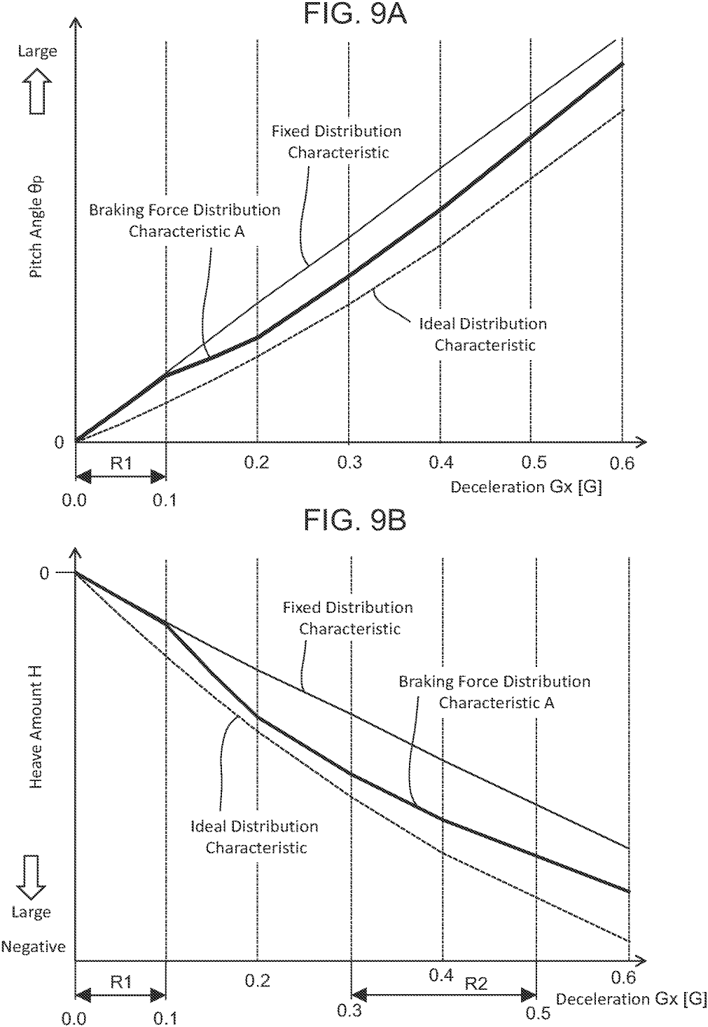

FIGS. 9A and 9B are graphs each used to describe effects of the braking force distribution characteristic A according to the embodiment. FIG. 9A shows a relation between the pitch angle θp and the deceleration Gx, and FIG. 9B shows a relation between the heave amount H and the deceleration Gx.

According to the braking force distribution characteristic A (see FIG. 8) of the present embodiment, in the low deceleration range R1, the brake device 20 is controlled such that the front-rear distribution ratio α is in accordance with the fixed distribution characteristic. Therefore, as shown in FIG. 9A, the pitch angle θp in the low deceleration range R1 is equal to the value obtained by the fixed distribution characteristic. That is, the pitch angle θp can be made larger than the value obtained by the ideal distribution characteristic. By actively generating a pitch change in comparison with the ideal distribution characteristic as described above, the pitch change can be quickly transmitted to a person onboard such as a driver through the visual sensation. Therefore, in the low deceleration range R1 in which the deceleration Gx during braking is low, it is possible to give the person onboard such as the driver with a deceleration feeling at an early stage. More specifically, by using the perception of a change in the visual sensation due to the movement of the head of the driver caused by the pitch change, it is possible to give the driver with a good deceleration feeling that the response of the vehicle 1 to the operation of the brake pedal 22 is good, before the driver perceives the deceleration Gx. This leads to an improvement in the driver’s feeling of security with respect to the braking performance.

Moreover, according to the braking force distribution characteristic A, in the medium deceleration range R2, the brake device 20 is controlled such that the front-rear distribution ratio α is biased toward the rear wheels 2R than the fixed distribution characteristic. Therefore, as shown in FIG. 9B, the heave amount H in the middle deceleration range R2 can be made larger than the value obtained by the fixed distribution characteristic. The heave change is transmitted to a person, such as a driver, as a change in the vertical acceleration Gz. Also, as described above, the heave change is easily perceived by the bodily sensation of the person onboard. Therefore, by actively increasing the heave amount H (i.e., diving of the vehicle body 4) in the middle deceleration range R2 as compared with the fixed distribution characteristic, it is possible to give the person onboard with a feeling of security that each wheel 2 of the vehicle 1 sticks to the road surface (i.e., a feeling of security against braking).

In addition, as can be seen from FIG. 9B, the ideal distribution characteristic can also be used to increase the heave change in the middle deceleration range R2. However, according to the ideal distribution characteristic, even in the low deceleration range R1, the front-rear distribution ratio α is biased toward the rear wheels 2R than that in the fixed distribution characteristic. For this reason, according to the ideal distribution characteristic, it is not possible to obtain the effect of giving the driver the feeling of deceleration at an early stage by actively generating a pitch change in the low deceleration range R1 (see FIG. 9A). Accordingly, in the braking force distribution characteristic A, the front-rear distribution ratio α is changed between the low deceleration range R1 and the medium deceleration range R2. As a result, a good braking force distribution characteristic is achieved in which the deceleration feeling can be improved in the low deceleration range R1 and the feeling of security against braking can be improved in the middle deceleration range R2. As described above, according to the braking force distribution characteristic A, the braking feeling can be favorably improved in a plurality of deceleration ranges (i.e., R1 and R2).

Additionally, the middle deceleration range R2 is a range in which the driver easily feels the deceleration Gx because the middle deceleration range R2 is on the higher deceleration side than the low deceleration range R1. According to the braking force distribution characteristic A, in this middle deceleration range R2, the pitch angle θp is reduced to be smaller than when the fixed distribution characteristic is selected (see FIG. 9A).

Furthermore, according to the braking force distribution characteristic A, in the high deceleration range R3, the brake device 20 is controlled such that the front-rear distribution ratio α is in accordance with the fixed distribution characteristic. If the braking force distribution characteristic A has a characteristic as indicated by a broken line L0 in FIG. 8, the front-rear distribution ratio α becomes biased toward the front wheels 2F than the fixed distribution characteristic in the high deceleration range R3. As a result, the braking load on the front wheels 2F increases. On the other hand, according to the braking force distribution characteristic A, in the high deceleration range R3, the load on the front wheel braking force can be reduced as compared with the characteristic of the broken line L0. Therefore, the reduction of the brake fade on the front wheel side and the securement of the understeer characteristic during braking can be satisfactorily achieved.

It should be noted that, in the example of the braking force distribution characteristic A shown in FIG. 8, the brake device 20 is controlled such that the front-rear distribution ratio α is in accordance with the fixed distribution characteristic in the entire low deceleration range R1 (first range). Instead of this example, with only a part of the low deceleration range R1 (first range) as a target, the brake device 20 may be controlled such that the front-rear distribution ratio α is in accordance with the fixed distribution characteristic in order to actively generate a pitch change to give a person onboard a feeling of deceleration at an early stage.

Moreover, when the regenerative braking force is used to change the front-rear distribution ratio α using the braking force distribution characteristic A (see FIG. 8), in-wheel motors may be used instead of the front wheel electric motor 10F and the rear wheel electric motor 10R that drive the front wheels 2F and the rear wheels 2R via the front wheel drive shaft 3F and the rear wheel drive shaft 3R, respectively. However, the point of application of the regenerative braking force in the example in which the in-wheel motors are used is different from the center position of each wheel 2 which is the point of application in the example in which the electric motors 10F and 10R are used, and is the same ground contact surface of each wheel 2 as the point of application in the example of the friction braking force. Therefore, the suspension displacement amounts ΔX_{f} and ΔXᵣ in the example in which the in-wheel motors are used are expressed by the following Equations (6) and (7).

$$\text{Δ} {X}_{f} = \left\{\frac{h}{{W}_{B}} - α ⋅ A n t i D i v e\right\} \frac{F}{{k}_{f}}$$

$$\text{Δ} {X}_{r} = - \left\{\frac{h}{{W}_{B}} - \left(1 - α\right) ⋅ A n t i L i f t \_ r\right\} \frac{F}{{k}_{r}}$$

Moreover, when the front-rear distribution ratio α is changed using the regenerative braking force, the electric motor (including the in-wheel motor) may be provided to drive only one of the front wheels and the rear wheels. Furthermore, the change of the front-rear distribution ratio α according to the braking force distribution characteristic A may be executed for a vehicle that does not have the regenerative braking force (i.e., a vehicle that uses only the friction braking force). In this example, the suspension displacement amounts ΔX_{f} and ΔXᵣ are expressed by Equations (6) and (7).

### 2-2. Issue on Front-Rear Braking Force Distribution Control

With respect to the front-rear braking force distribution control using the braking force distribution characteristic A (see FIG. 8), an issue on an improvement in a braking feeling (i.e., a feeling of security against braking) using a heave change (i.e., a vertical change of the vehicle body 4) in the middle deceleration range R2 will be described here.

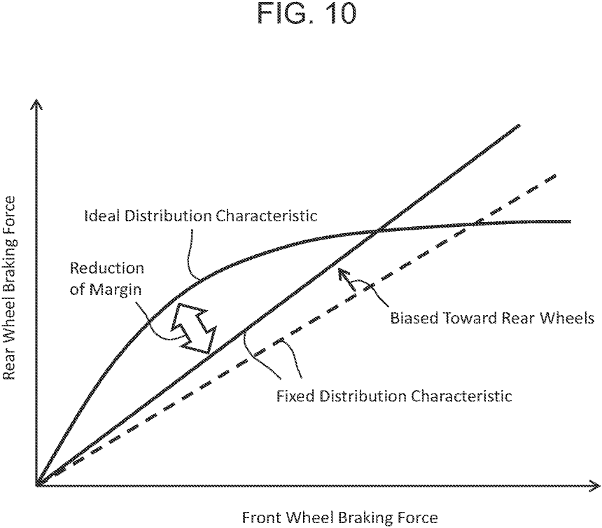

FIG. 10 is a graph used to describe an issue caused by a brake specification. The fixed distribution characteristic is determined by a brake specification such as brake capacity (for example, sizes of a brake caliper and a brake rotor). As illustrated by a solid line and a broken line in FIG. 10, when the front-rear distribution ratio α is biased toward the rear wheels due to a difference in the brake specification, the inclination of the braking force distribution line (i.e., equal hydraulic pressure distribution line) that indicates the fixed distribution characteristic increases. As a result, the margin of the fixed distribution characteristic with respect to the ideal distribution characteristic is reduced. Setting the front-rear distribution ratio α to be biased toward the rear wheels than that in the ideal distribution characteristic is not appropriate because deterioration in vehicle stability such as early locking of the rear wheels may be caused. Therefore, in a vehicle having a brake specification with little margin with respect to the ideal distribution characteristic as in the example of the fixed distribution characteristic indicated by the solid line in FIG. 10, it is difficult to make the front-rear distribution ratio α in the medium deceleration range R2 sufficiently biased toward the rear wheels by using the braking force distribution characteristic A (see FIG. 8). This leads to a difficulty in obtaining the effect of improving a feeling of braking using the heave change.

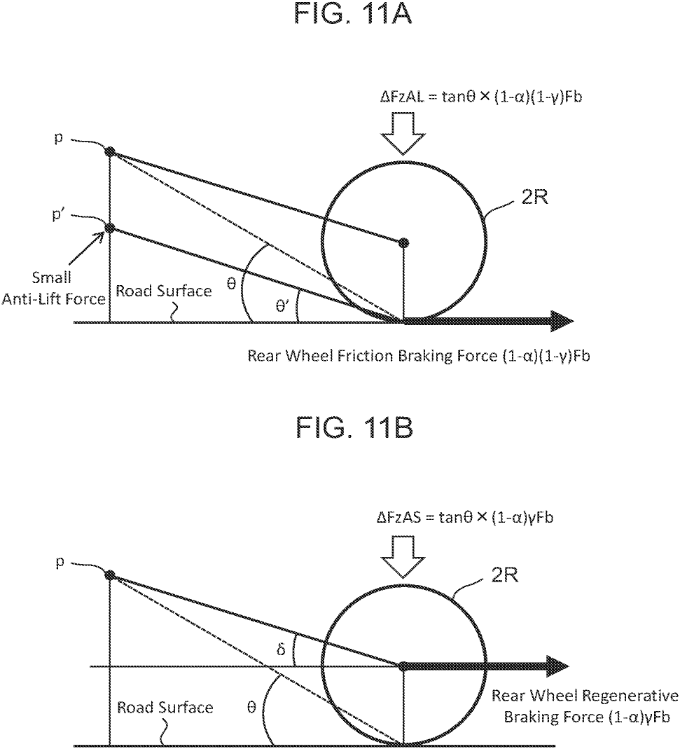

Then, FIGS. 11A and 11B are diagrams used to describe issues caused by the suspension reaction force at the time of braking.

As described with reference to FIG. 9B, by setting the front-rear distribution ratio α to be biased toward the rear wheels in accordance with the braking force distribution characteristic A, an increase in the heave amount H can be promoted so as to improve a feeling of braking by the effect of anti-lift geometry of the suspension 40R of the rear wheels 2R.

However, as illustrated in FIG. 11A, when the anti-lift geometry of the suspension of the rear wheels is designed such that the anti-lift force becomes small, it is difficult to obtain a feeling of braking using an increase in the heave amount H in the vehicle downward direction. Specifically, as shown in FIG. 11A, an anti-lift force ΔFzAL is a value (1-α)(1-γ)Fb×tanθ based on an angle θ from a ground contact point of the rear wheel 2R to an instantaneous rotation center p and the rear wheel friction braking force (1-α)(1-γ)Fb. For this reason, in a vehicle having the anti-lift geometry in which the height of the instantaneous rotation center is low as in an instantaneous rotation center p′ illustrated in FIG. 11A, the angle θ becomes small as in an angle θ′, and as a result, the anti-lift force ΔFzAL becomes small.

Moreover, when the regenerative torque of the electric motor 10R is transmitted to the rear wheels 2R via the rear wheel drive shaft 3R in a vehicle using the regenerative braking force to brake the rear wheels 2R as in the vehicle 1 of the present embodiment, the point of application of the regenerative braking force (1-α)γFb of the rear wheel 2R is different from the point of application of the rear wheel friction braking force (1-α)(1-γ)Fb. An increase in the heave amount H in the vehicle downward direction can also be promoted by the effect of anti-squat geometry using the rear wheel regenerative braking force (1-α)γFb acting in this manner.

However, the reference plane of an angle δ that affects an anti-squat force ΔFzAS (= (1-α)γFb×tanδ) which is a suspension reaction force based on the rear wheel regenerative braking force (1-α)γFb is located at the center of the rear wheel 2R as shown in FIG. 11B. As can be seen from the comparison between the angle θ associated with the instantaneous rotation center p in FIG. 11B and the angle δ (δ < θ), the anti-squat force ΔFzAS based on the rear wheel regenerative braking force (1-α)γFb is smaller than an anti-lift force based on the rear wheel friction braking force having the same magnitude as this rear wheel regenerative braking force (1-α)γFb. Therefore, in the vehicle using the rear wheel regenerative braking force acting as shown in FIG. 11B, it is difficult to obtain the effect of improving a feeling of braking using an increase in the heave amount H as compared with a vehicle using only the friction braking force to brake the rear wheels 2R. In addition, in an example in which the friction braking force and the regenerative braking force are used together for braking the rear wheels 2R, the larger the ratio of the regenerative braking force is, the more difficult it is to obtain the improvement effect.

### 2-3. Front-Rear Braking Force Distribution Control with Front-Rear Damping Force Control

In the present embodiment, in order to further enhance or supplement the effect of improving a feeling of braking by the front-rear braking force distribution control described above, the front-rear braking force distribution control is executed in association with the following front rear damping force control.

To be specific, according to the front-rear damping force control, in a specific deceleration range Rs, a compression-side damping force Fdf of each front wheel damper 44F (see FIG. 3) is made smaller than in the low deceleration range R1, and an extension-side damping force Fdr of each rear wheel damper 44R is made larger than in the low deceleration range R1. The specific deceleration range Rs referred to here is a required deceleration range that includes the medium deceleration range R2 and is located on the higher deceleration side than the low deceleration range R1. As an example, the specific deceleration range Rs is the ranges R2′ and R3 (see FIG. 8), as shown in FIG. 13 described below. However, the specific deceleration range Rs may be freely set as long as the range Rs includes the medium deceleration range R2, and may be, for example, a range equal to or higher than the medium deceleration range R2, or only the medium deceleration range R2.

FIG. 12 is a flowchart showing processing related to vehicle control according to the embodiment. The processing of this flowchart is repeatedly executed during the travel of the vehicle 1.

In FIG. 12, in step S100, the ECU 50 determines whether or not the vehicle 1 is braking. This determination can be made, for example, based on whether or not the amount of depression of the brake pedal 22 detected by the brake position sensor is equal to or greater than a designated threshold value.

As a result, when it is determined in step S100 that the vehicle 1 is not braking, the processing proceeds to RETURN. On the other hand, when the vehicle 1 is braking, the processing proceeds to step S102.

In step S102, the ECU 50 calculates a required deceleration Gxr. The required deceleration Gxr is calculated based on, for example, the amount of depression of the brake pedal 22. Alternatively, the required deceleration Gxr may be calculated based on the master cylinder pressure, for example.

Then, in step S104, the ECU 50 executes the front-rear braking force distribution control in consideration of the vehicle posture. The memory device 54 of the ECU 50 stores, as a map, the braking force distribution characteristic A (refer to FIG. 8) specified based on a relation among the front wheel braking force, the rear wheel braking force, and the required deceleration Gxr. The ECU 50 calculates a target front wheel braking force Fbft and a target rear wheel braking force Fbrt according to the current required deceleration Gxr from this kind of map.

Then, the ECU 50 controls the brake device 20 so as to generate the calculated target front wheel braking force Fbft and target rear wheel braking force Fbrt. More specifically, as described above, in the present embodiment, the ratios (regenerative distribution ratios) β and γ are constant as an example. The target front wheel braking force Fbft is distributed to a target front wheel friction braking force and a target front wheel regenerative braking force in accordance with the ratio β. The target rear wheel braking force Fbrt is distributed to a target rear wheel friction braking force and a target rear wheel regenerative braking force in accordance with the ratio γ. The ECU 50 controls the brake device 20 (more specifically, the friction brake device 33 and the regenerative brake device 34) so as to generate the target friction braking force and the target regenerative braking force.

In other words, the braking force distribution characteristic A defines the front-rear distribution ratio α according to the required deceleration Gxr. Therefore, controlling the front wheel braking force αFb and the rear wheel braking force (1-α)Fb using the map described above corresponds to controlling the front-rear distribution ratio α in accordance with the required deceleration Gxr.

In addition, instead of the map described above, in step S104, a map that directly defines the relation between the required deceleration Gxr and the front-rear distribution ratio α that is specified by the braking force distribution characteristic A (see FIG. 8) may be used, for example. Then, the ECU 50 may calculate the target braking force Fbt, which is a target value of the total braking force Fb, based on the amount of depression of the brake pedal 22 or the master cylinder pressure, for example. Then, the ECU 50 may calculate the target front wheel braking force Fbft and the target rear wheel braking force Fbrt from the calculated target braking force Fbt and the front-rear distribution ratio α calculated from the map in accordance with the required deceleration Gxr.

Then, in step S106, the ECU 50 executes the front-rear damping force control. Specifically, the ECU 50 calculates a target damping force Fdft on the compression side of each front wheel damper 44F and a target damping force Fdrt on the extension side of each rear wheel damper 44R that are used during braking.

FIG. 13 is a diagram showing an example of the manner of calculating the target damping forces Fdft and Fdrt of the front and rear wheel dampers 44F and 44R. FIG. 13 shows a relation between a basic damping force Fdf0 on the compression side of each front wheel damper 44F and piston speed Vp (i.e., the stroke speed of each suspension 40F). FIG. 13 also shows a relation between a basic damping force Fdr0 on the extension side of each rear wheel damper 44R and piston speed Vp. It should be noted that, in FIG. 13, the sign of the damping force Fd is positive on the extension side and negative on the compression side.

The basic damping forces Fdf0 and Fdr0 change in accordance with the piston speed Vp. More specifically, as shown in FIG. 13, when the absolute value of the piston speed Vp increases, the absolute values of the basic damping forces Fdf0 and Fdr0 also increase.

Moreover, FIG. 13 shows a relation between a damping force gain gdf on the compression side of each front wheel damper 44F and the required deceleration Gxr, and a relation between a damping force gain gdr on the extension side of each rear wheel damper 44R and the required deceleration Gxr.

Specifically, as shown in FIG. 13, the damping force gain gdf is 1.0 in the low deceleration range R1, and is a designated value g1 in the medium deceleration range R2. The designated value g1 is a value greater than 0 and smaller than 1.0. In an example shown in FIG. 13, the damping force gain gdf is constant at the designated value g1 even in a range on the higher deceleration side than the medium deceleration range R2. In addition, in a range located between the low deceleration range R1 and the medium deceleration range R2, the damping force gain gdf decreases from 1.0 to the designated value g1 at a constant gradient, for example.

On the other hand, as shown in FIG. 13, the damping force gain gdr is 1.0 in the low deceleration range R1 and is a designated value g2 in the medium deceleration range R2. The designated value g2 is a value greater than 1.0. In an example shown in FIG. 13, the damping force gain gdr is constant at the designated value g2 even in a range on the higher deceleration side than the medium deceleration range R2. In addition, in the range located between the low deceleration range R1 and the medium deceleration range R2, the damping force gain gdr increases from 1.0 to the designated value g2 at a constant gradient, for example.

The memory device 54 of the ECU 50 stores, as maps, a relation between the basic damping force Fdf0 and the piston speed Vp and a relation between the basic damping force Fdr0 and the piston speed Vp as shown in FIG. 13. The ECU 50 calculates, from the maps, the basic damping forces Fdf0 and Fdr0 according to the respective piston speeds Vp obtained using, for example, the suspension stroke sensors.

The memory device 54 also stores, as maps, a relation between the damping force gain gdf and the required deceleration Gxr, and the relation between the damping force gain gdr and the required deceleration Gxr as shown in FIG. 13. The ECU 50 calculates, from the maps, the damping force gains gdf and gdr according to the required deceleration Gxr calculated in step S102.

The ECU 50 calculates the product of the calculated basic damping force Fdf0 and damping force gain gdf as the target damping force Fdft on the compression side of each front wheel damper 44F. Also, the ECU 50 calculates the product of the calculated basic damping force Fdr0 and the damping force gain gdr as the target damping force Fdrt on the extension side of each rear wheel damper 44R.

Then, the ECU 50 controls the actuator 46 of each front wheel damper 44F such that the calculated target damping force Fdft is realized, and controls the actuator 46 of each rear wheel damper 44R such that the calculated target damping force Fdrt is realized.

### 3. Effect

As described above, according to the present embodiment, the front-rear braking force distribution control is executed during braking. The effect of the front-rear braking force distribution control is as described with reference to FIGS. 9A and 9B. This effect includes providing a person onboard with a feeling of security such that each wheel 2 of the vehicle 1 sticks to the road surface (that is, a feeling of security against braking) by actively generating a change in the heave amount H (i.e., diving of the vehicle body 4) in the downward direction of the vehicle 1 in the medium deceleration range R2.

Also, according to the front-rear damping force control (see step S106), in the specific deceleration range Rs including the medium deceleration range R2, the front wheel dampers 44F and the rear wheel dampers 44R are respectively controlled such that the compression-side damping force Fdf of each front wheel damper 44F is made smaller and the extension-side damping force Fdr of each rear wheel damper 44R is made larger than those in the low deceleration range R1. As a result, in the specific deceleration range Rs including the medium deceleration range R2, a transitional change in the vehicle posture in the process until reaching the vehicle braking posture based on the braking force distribution characteristic A (see FIG. 8) is controlled, and the feeling that the vehicle body 4 dives (that is, the feeling of security against braking) can thereby be easily given to the person onboard.

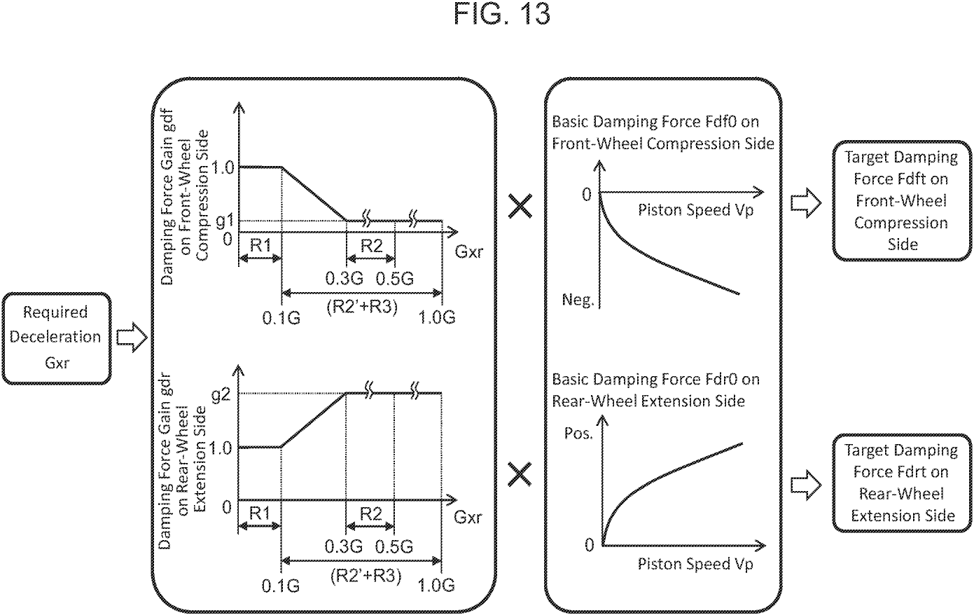

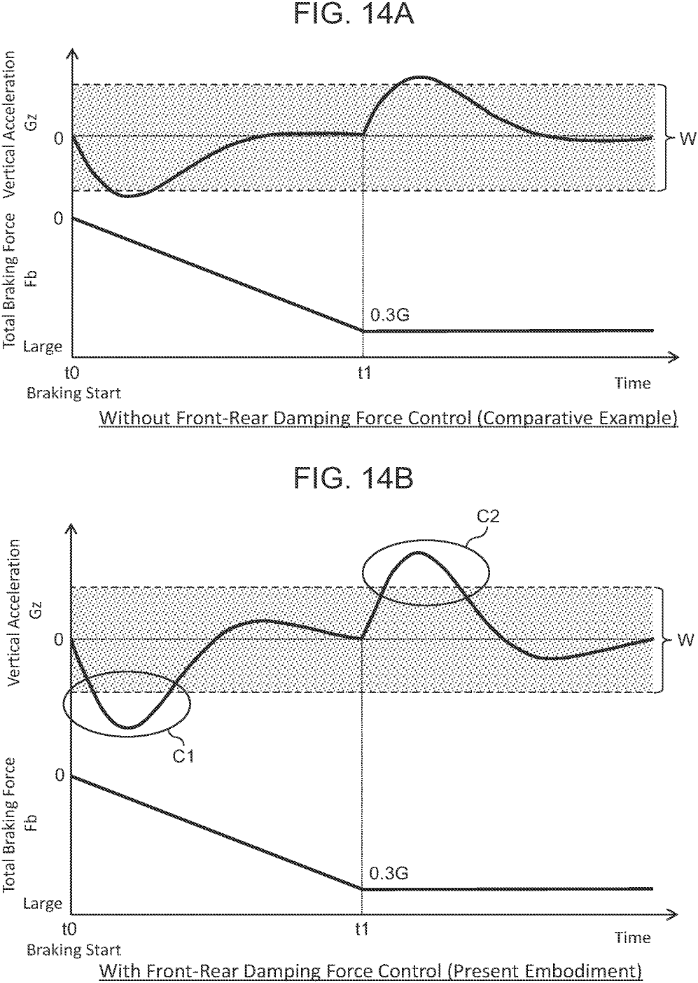

More specifically, FIGS. 14A and 14B are time charts used to describe an effect of the front-rear damping force control according to the embodiment. FIG. 14A is referred to for comparison with the present embodiment, and is associated with a comparative example (without the front-rear damping force control) in which the front and rear damping forces Fdf and Fdr are fixed regardless of the required deceleration Gxr. FIG. 14B is associated with an example with the front-rear damping force control according to the present embodiment. The upper graphs in these figures show waveforms of the vertical acceleration Gz in the vertical direction of the vehicle 1 obtained by differentiating the heave amount H at the position of a person onboard twice with respect to time. The lower graphs show waveforms of the total braking force Fb. A time point t0 indicates a braking start point in time. A time point t1 indicates a time point at which the total braking force Fb reaches a value associated with 0.3G, which is an example of the required deceleration Gxr.

A change in the vertical acceleration Gz in the process of reaching the vehicle braking posture based on the braking force distribution characteristic A can be controlled by adjusting the front and rear damping forces Fdf and Fdr. In other words, a transitional change in the vehicle posture can be controlled. As described above, a person onboard such as a driver perceives a heave change through a change in the vertical acceleration Gz. Therefore, even when the braking is performed at the same front-rear distribution ratio α, the manner in which the person onboard perceives the heave change is changed by the adjustment of the front and rear damping forces Fdf and Fdr, and accordingly, the feeling of braking (i.e., the feeling of security against braking) may be changed. Therefore, in the present embodiment, the front-rear damping force control is performed.

Specifically, the medium deceleration range R2 is a range in which it is desirable to actively generate a change in the heave amount H (i.e., diving of the vehicle body 4) in the downward direction of the vehicle 1 by using the braking force distribution characteristic A in order to improve the feeling of security against braking. According to the front-rear damping force control, in the specific deceleration range Rs including the medium deceleration range R2, the front-rear damping force balance is changed such that the damping force Fdf on the front-wheel compression side is smaller and the damping force Fdr on the rear-wheel extension side is larger than those in the low deceleration range R1. By changing the front-rear damping force balance in this way, the motion of the suspension 40R that tends to lift the rear wheel side of the vehicle body 4 can be made gentle, and the motion of the suspension 40F that tends to dive the front wheel side of the vehicle body 4 can be quickly generated.

As a result, the heave change (i.e., the change in the vertical acceleration Gz) in the downward direction of the vehicle 1 can be promoted in the process of reaching the steady vehicle braking posture (more specifically, pitch posture) according to the required deceleration Gxr. The change in the vertical acceleration Gz promoted in this manner is expressed by a circle C1 in FIG. 14B. That is, as can be seen from a comparison with FIG. 14A, the amount of change in the downward vertical acceleration Gz increases in the initial stage of braking in which the required deceleration Gxr in the medium deceleration range R2 is required. More specifically, when the change in the vertical acceleration Gz along with the change in the heave amount H is downward, the person onboard obtains a feeling that the vehicle body 4 dives. Therefore, a feeling that the vehicle body 4 dives can be actively given to the person in the vicinity of the circle C1 where the amount of change in the downward vertical acceleration Gz is large. Thus, the feeling of security against braking can be improved.

Moreover, as indicated by a circle C2 in FIG. 14B, a large change in the vertical acceleration Gz in the upward direction of the vehicle 1 is generated immediately after the time point t1 at which the total braking force Fb according to the required deceleration Gxr is reached (that is, when a steady braking posture is obtained). According to this kind of change in the vertical acceleration Gz, when the change in the heave amount H in the downward direction of the vehicle is subsided, a feeling that the body is pressed downward can be actively given to the person onboard whose body is moving in the downward direction of the vehicle 1 together with the vehicle body 4. This can also improve the feeling of security against braking.

A range W of the vertical acceleration Gz illustrated in FIGS. 14A and 14B indicates a range in which a person cannot perceive a change in the vertical acceleration Gz. It is understood that the amount of change in the vertical acceleration Gz can be effectively increased with respect to the range W by performing the front-rear damping force control. As described above, according to the front-rear damping force control, the feeling of security against braking can be improved by using a large change in the vertical accelerations Gz (i.e., a transitional change in the vehicle posture) occurring in the vicinity of the circles C1 and C2.

In addition, when the damping force Fdf on the front-wheel compression side is controlled to be large and the damping force Fdr on the rear-wheel extension side is controlled to be small contrary to the front-rear damping force balance by the front-rear damping force control according to the present embodiment, the movement of each suspension 40R to lift the rear wheel side of the vehicle body 4 occurs earlier than the movement of the front wheel side of the vehicle body 4 at the initial stage of braking. As a result, a feeling that the vehicle body 4 dives is not given to a person onboard or is hardly given to the person.

As described above, by causing the front-rear damping force control to accompany the front-rear braking force distribution control, the effect of improving the braking feeling by the front-rear braking force distribution control can be further enhanced. Also, even in a vehicle in which the use of the heave change is difficult to improve the braking feeling as described with reference to FIGS. 10, 11A, and 11B, the braking feeling can be favorably improved (in other words, supplemented) by the action of the front-rear damping force control.

### 4. Modification Example Related to Calculation of Target Damping Force

In the embodiment described above, the target damping forces Fdft and Fdrt are calculated using the damping force gains gdf and gdr, respectively, so as to have values according to the required deceleration Gxr. Instead of this example, the target damping forces Fdft and Fdrt may be calculated by the following method using damping coefficients Cdf and Cdr that are changed in accordance with the required deceleration Gxr.

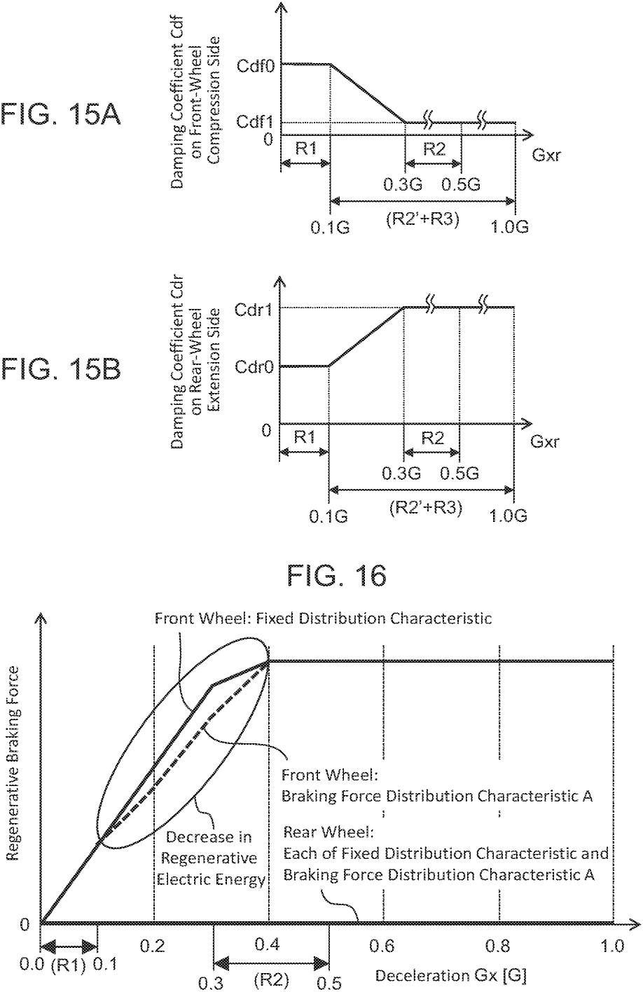

FIGS. 15A and 15B are graphs respectively illustrating an example of setting of the damping coefficients Cdf and Cdr according to a modification example of the embodiment. In this modification example, the target damping force Fdft on the compression side of the front wheel damper 44F is calculated as the product of the piston speed Vp of the front wheel damper 44F and the damping coefficient Cdf. Similarly, the target damping force Fdrt on the extension side of the rear wheel damper 44R is calculated as the product of the piston speed Vp of the rear wheel damper 44R and the damping coefficient Cdr.

As shown in FIG. 15A, the damping coefficient Cdf on the front-wheel compression side is a designated value Cdf0 in the low deceleration range R1, and is a designated value Cdf1 in the medium deceleration range R2. The designated value Cdf1 is a value greater than 0 and smaller than the designated value Cdf0. In an example shown in FIG. 15A, even in a range on the higher deceleration side than the medium deceleration range R2, the damping coefficient Cdf is constant at the designated value Cdf1. In addition, in the range located between the low deceleration range R1 and the medium deceleration range R2, the damping coefficient Cdf decreases from the designated value Cdf0 to the designated value Cdf1 at a constant gradient, for example.

On the other hand, as shown in FIG. 15B, the damping coefficient Cdr on the rear-wheel extension side is the designated value Cdr0 in the low deceleration range R1, and is the designated value Cdr1 in the medium deceleration range R2. The designated value Cdr1 is a value greater than the designated value Cdr0. In an example shown in FIG. 15B, the damping coefficient Cdr is constant at the designated value Cdr1 even in a range on the higher deceleration side than the medium deceleration range R2. In addition, in the range located between the low deceleration range R1 and the medium deceleration range R2, the damping coefficient Cdr increases from the designated value Cdr0 to the designated value Cdr1 at a constant gradient, for example.

In this modification example, the memory device 54 of the ECU 50 stores, as maps, a relation between the damping coefficient Cdf and the required deceleration Gxr as shown in FIG. 15A and a relation between the damping coefficient Cdr and the required deceleration Gxr as shown in FIG. 15B. The ECU 50 calculates, from the maps, the damping coefficients Cdf and Cdr according to the required deceleration Gxr calculated in step S102 (see FIG. 12). As described above, the piston speed Vp can be obtained using, for example, the suspension stroke sensors.

Even with the modification example described above, the target damping forces Fdft and Fdrt for realizing the front-rear damping force balance according to the above-described front-rear damping force control can be calculated.

### 5. Modification Examples Related to Execution of Front-Rear Damping Force Control

The front-rear damping force control described above may be executed together with the front-rear braking force distribution control executed as follows.

FIG. 16 is a graph used to describe an issue on the braking force distribution characteristic A related to securing regenerative electric energy. With respect to the range R2′ including the medium deceleration range R2, in the braking force distribution characteristic A (see FIG. 8) used to change the vehicle posture during braking in accordance with the deceleration Gx, the braking force distributed to the front wheels 2F is smaller than in the fixed distribution characteristic. As a result, when the regenerative braking of the front wheels 2F is used, the amount of regenerative electric energy obtained on the front wheel side decreases as compared with when the fixed distribution characteristic is selected. Therefore, for example, in a vehicle in which the regenerative braking is performed only on the front wheel side, the amount of regenerative electric energy obtained at the time of deceleration may decrease, and, as a result, the energy consumption efficiency of the vehicle may decrease. It should be noted that the term “energy consumption efficiency” referred to here corresponds to fuel efficiency (km/l) in an example of HEV, and electricity efficiency (km/kWh) in an example BEV. FIG. 16 shows a relation between the regenerative braking force and the deceleration Gx in an example in which the regenerative braking is used only at the front wheels 2F. In the example shown in FIG. 16, the regenerative distribution ratio (i.e., ratio β) on the side of the front wheels 2F is made variable such that the regenerative braking force is constant in a deceleration range of 0.4G or more, and a decrease in the regenerative electric energy is seen in a deceleration range higher than 0.1G and lower than 0.4G.

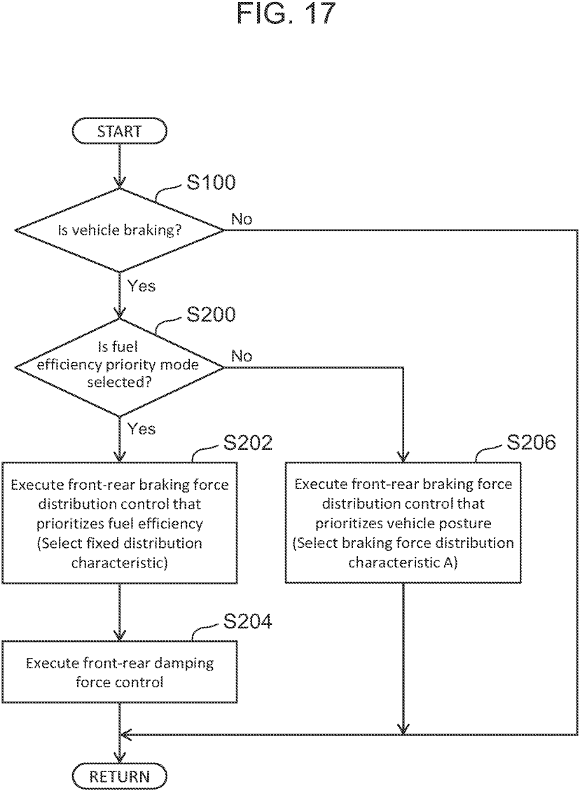

Accordingly, in view of the issue described above, the front-rear braking force distribution control and the front-rear damping force control may be executed as follows. FIG. 17 is a flowchart showing processing related to vehicle control according to a modification example of the embodiment. The processing of this flowchart is repeatedly executed during the travel of a vehicle. The vehicle assumed here has the same configuration as the vehicle 1 shown in FIG. 1 except that the regenerative braking is used only on the front wheel side.

In FIG. 17, when it is determined in step S100 that the vehicle is braking, the processing proceeds to step S200. In step S200, the ECU 50 determines whether or not a fuel efficiency priority mode (i.e., energy consumption efficiency priority mode) is selected by the driver. The driver can switch the traveling mode of the vehicle using, for example, the mode change switch 58. An example of the traveling mode to be switched includes a normal mode, the fuel efficiency priority mode (i.e., an economy mode), and a sport mode.

When the determination result of step S200 is Yes (that is, when a request to prioritize the fuel efficiency is made by the driver), the processing proceeds to step S202. In step S202, the ECU 50 selects the fixed distribution characteristic (for example, see FIG. 8) in which the front-rear distribution ratio α is constant regardless of the required deceleration Gxr, as the braking force distribution characteristic that emphasizes the improvement of the fuel efficiency. It should be noted that, when there is a request to prioritize the fuel efficiency, the selection of the fixed distribution characteristic by the processing in step S202 may be executed only for a deceleration range (for example, see FIG. 16) in which the regenerative electric energy is insufficient due to the selection of the braking force distribution characteristic A.

In step S204 following step S202, the ECU 50 executes the front-rear damping force control described above (see step S106).

On the other hand, when the determination result of step S200 is No (that is, when a request to prioritize the fuel efficiency is not made), the processing proceeds to step S206. In step S206, the ECU 50 selects the braking force distribution characteristic A (see FIG. 8) as the braking force distribution characteristic that emphasizes the vehicle posture during braking. It should be noted that, when the processing proceeds to step S206, the front-rear damping force control is not executed.

According to the above-described processing shown in FIG. 17, when there is a request to prioritize the fuel efficiency, the front-rear braking force distribution control is executed by selecting the fixed distribution characteristic instead of the braking force distribution characteristic A, and the front-rear damping force control is executed. As a result, a larger braking force on the side of the front wheels 2F can be secured as compared with when the braking force distribution characteristic A is selected, and a higher amount of the regenerative electric energy can thus be secured using the regenerative braking. Therefore, the fuel efficiency can be improved.

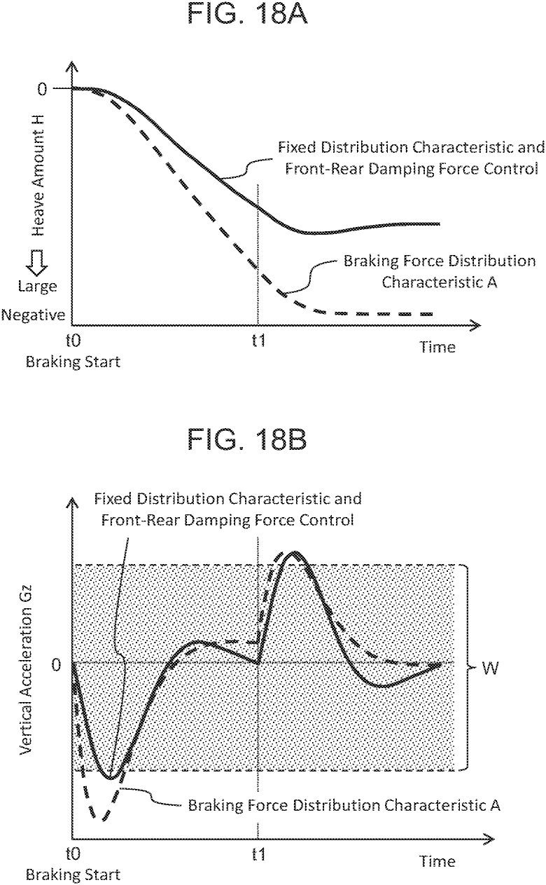

Moreover, when there is a request to prioritize the fuel efficiency, the front-rear damping force control is executed. FIGS. 18A and 18B are graphs used to describe the effects of the processing in steps S202 and S204. As an example, FIGS. 18A and 18B are associated with braking in which a deceleration Gx of 0.3G is requested.

As shown in FIG. 18A, in an example in which the fixed distribution characteristic is selected (solid line), the heave amount H decreases as compared with an example in which the braking force distribution characteristic A that considers the vehicle posture is selected (broken line). However, when the fixed distribution characteristic is selected (solid line), the front-rear damping force control is executed. For this reason, as shown in FIG. 18B, an amount of change in the vertical acceleration Gz larger than that in the range W in which a person cannot perceive a change in the vertical acceleration Gz can be secured, although the amount is smaller than that in the example in which the braking force distribution characteristic A is selected (broken line). Therefore, when the fuel efficiency priority mode is selected, it is possible to satisfy the fuel efficiency priority request by securing a high amount of the regenerative electric energy using the fixed distribution characteristic while improving the braking feeling by the control of a transitional vehicle posture using the front-rear damping force control.

Furthermore, in the front-rear damping force control according to the embodiment described above, in the specific deceleration range Rs including the medium deceleration range R2 (second range), both of reducing the damping force Fdf on the front-wheel compression side and increasing the damping force Fdr on the rear-wheel extension side as compared with the low deceleration range R1 (first range) are executed. However, the front-rear damping force control for obtaining a front-rear damping force balance that improves a feeling of security against braking by using a change in the vertical acceleration Gz (i.e., a transitional change in the vehicle posture) in the specific deceleration range Rs may not necessarily be performed by controlling both of the damping forces Fdf and Fdr. That is, only one of reducing the damping force Fdf on the front-wheel compression side and increasing the damping force Fdr on the rear-wheel extension side may be executed.

What is claimed is:

1. A vehicle, comprising:
a brake device configured to change a front-rear distribution ratio of wheel braking force;
a suspension including at least one of a front wheel damper with variable damping force and a rear wheel damper with variable damping force; and
an electronic control unit configured to:
control the brake device such that, in at least a part of a first range being a required deceleration range lower than a lower limit value of a vehicle deceleration perceivable by a person in the vehicle, the front-rear distribution ratio is constant regardless of the vehicle deceleration, and, in a second range in which the vehicle deceleration is higher than that in the first range, the front-rear distribution ratio is biased toward a rear wheel than in the first range;and
in a specific deceleration range including the second range and higher than the first range, execute at least one of reducing a compression-side damping force of the front wheel damper compared with the first range and increasing an extension-side damping force of the rear wheel damper compared with the first range.

2. The vehicle according to claim 1, wherein
in the specific deceleration range, the electronic control unit is configured to both of reducing the compression-side damping force of the front wheel damper compared with the first range and increasing the extension-side damping force of the rear wheel damper compared with the first range.

3. The vehicle according to claim 1, wherein
a target value of the compression-side damping force of the front wheel damper is a product of a basic damping force according to a piston speed of the front wheel damper and a damping force gain determined to be smaller in the specific deceleration range than in the first range, and
a target value of the extension-side damping force of the rear wheel damper is a product of a basic damping force according to a piston speed of the rear wheel damper and a damping force gain determined to be greater in the specific deceleration range than in the first range.

4. The vehicle according to claim 1, wherein
a target value of the compression-side damping force of the front wheel damper is a product of a piston speed of the front wheel damper and a damping coefficient determined to be smaller in the specific deceleration range than in the first range, and
a target value of the extension-side damping force of the rear wheel damper is a product of a piston speed of the rear wheel damper and a damping coefficient determined to be greater in the specific deceleration range than in the first range.

5. A method of controlling a vehicle including a brake device configured to change a front-rear distribution ratio of wheel braking force, and a suspension including at least one of a front wheel damper with variable damping force and a rear wheel damper with variable damping force, the method comprising:
controlling the brake device such that, in at least a part of a first range being a required deceleration range lower than a lower limit value of a vehicle deceleration perceivable by a person in the vehicle, the front-rear distribution ratio is constant regardless of the vehicle deceleration, and, in a second range in which the vehicle deceleration is higher than that in the first range, the front-rear distribution ratio is biased toward a rear wheel than in the first range; and
in a specific deceleration range including the second range and higher than the first range, executing at least one of reducing a compression-side damping force of the front wheel damper compared with the first range and increasing an extension-side damping force of the rear wheel damper compared with the first range.
